(19) United States
(12) Patent Application Publication
(10) Pub. No.: US 2009/0328093 A1
(43) Pub. Date: Dec. 31, 2009

(54) Multimedia Content Filtering

(75) Inventors: James Leonard Cansler, Cedar Park, TX (US); Charles Varnon Scott, Austin, TX (US); Scott Anthony White, Austin, TX (US)

Correspondence Address: AT&T Legal Department - JW;Attn: Patent Docketing, Room 2A-207, One AT&T Way, Bedminster, NJ, 07921, US

(73) Assignee: AT&T INTELLECTUAL PROPERTY I, L.P., Reno, NV (US)

(21) Appl. No.: 12/165,645

(22) Filed: Jun. 30, 2008

(51) Int. Cl. H04N 7/16; G06F 3/00

(52) U.S. Cl. 725/28; 348/569; 715/716; 348/E05.105

(57) ABSTRACT

A disclosed method for facilitating automated and user-specific filtering of multimedia content includes a backend server receiving a content identifier from a user's multimedia handling device (MHD), e.g., a set top box. The content identifier indicates of a program of multimedia content (PMC) requested or otherwise desired by a user. The disclosed method includes identifying or otherwise locating an index file associated with the requested PMC. The index file includes data that indicates portions of the PMC containing potentially objectionable content. Content filtering (CF) settings associated with the user are retrieved or otherwise accessed. The CF settings define at least one type of content that is objectionable to the user. The CF settings are applied to the index file to identify a portion of the PMC containing content objectionable to the user. Content location information that indicates the identified portion of the PMC is then sent to the MHD.

### BACKGROUND

1. Field of the Disclosure

The disclosed subject matter generally relates to the distribution and consumption of multimedia content and, more particularly, controlling or restricting access to potentially objectionable multimedia content.

2. Description of the Related Art

In the field of television and other multimedia and entertainment applications, features exist to give parents or others with supervisory roles limited control over content that children may listen to, watch, or both. The V-chip, for example, enables parents to use TV ratings as a rough proxy for acceptable and unacceptable children's content.

### BRIEF DESCRIPTION OF THE DRAWINGS

FIG. 1 is a block diagram of selected elements of an embodiment of a multimedia distribution network;

FIG. 2 is a block diagram of selected elements of an embodiment of a multimedia handling device;

FIG. 3 is a block diagram of selected elements of an application server in a multimedia content distribution network;

FIG. 4 is a flow diagram illustrating selected elements of an embodiment of a method for facilitating the automated and user-specific filtering of multimedia content;

FIG. 5 is a flow diagram illustrating selected elements of an embodiment of a method for modifying multimedia content based on user-defined content objections;

FIG. 6 is a flow diagram illustrating selected elements of an embodiment of a content filtering service; and

FIG. 7 is a flow diagram illustrating selected elements of an embodiment of a content filtering application.

### DESCRIPTION OF THE EMBODIMENT(S)

Subject matter disclosed herein includes subject matter enabling a user to filter content according to one or more user specified filter settings. The user specifies settings defining objectionable content. Objectionable content may include specific language, certain types of scenes, and so forth, defined by the user. When the user or another viewer tunes to or otherwise requests a show, referred to herein as a program of multimedia content (PMC), the content filter settings are used to filter portions of the show containing content defined by the user to be objectionable. The PMC may be pre-recorded content. A great deal of content is not displayed live due for various reasons including a desire by broadcasters, distributors, and sponsors to avoid potentially embarrassing violations of FCC restrictions on broadcast content.

Content filtering functionality disclosed herein includes functionality enabling a multimedia handling device such as a set top box to send a content identifier and the user defined filter settings to a backend system. The backend system may use the filter data to query or search an index file associated with the identified content to determine chronological locations of content that is objectionable to the user. The index file may be implemented as an outline of the audio and video content of a show, program, or other type of multimedia content object. The index file might, in some embodiments, include scripts, tags, or other information that identifies the locations of predetermined types of content. For example, the index file might indicate the chronological location of scenes that include explicit or implied violence, profanity, hatred, sexuality, or any other type of content that a parent or other use might view as objectionable.

The index file may be supplied by an owner or distributor of the content. Alternately, the index file might be generated by the backend system by extrapolating the locations of objectionable content using speech analysis tools such as speech recognition tools or speech-to-text tools as well as visual analysis tools, or other techniques. Regardless of the method by which an index file is created, the index file may include data that a suitably configured filtering application could use to filter content in real-time based on user preference.

When a user selects a show, the set top box communicates a content identifier to a backend system. The set top box may communicate or may have previously communicated the user's filtering settings to the back end system. A filtering application on the backend system receives the content identifier and locates a previously generated index file associated with the identified content. The backend filtering application may then apply the user's filtering settings to the index file and determine the location of objectionable content. The backend filtering application may then deliver the content location information to the user. The content location information might indicate the beginning and ending of scenes or other passages that contain objectionable content. The content location information might be time based or based on some other type of information such as a frame identification. As the backend system streams or otherwise delivers the identified content to the set top box of the user, a filtering application executing on the user side, e.g., executing on the user's set top box, may access the content location information and use it to determine when to censor the content as it is provided to a display device at the user premises.

If a user found the word “tree” to be offensive, for example, the user can incorporate an applicable filtering setting into the user's filtering settings. When a new piece of content is requested, the filtering application on the set top box may communicate with the backend filtering application to determine when the word “tree” is spoken. In a time-based embodiment, the backend filtering application might return a start and end time for each instance of the “tree” and the user-side filtering application could censor the content, for example, by playing a “bleep” or not playing any audio when “tree” is spoken.

This disclosed filtering functionality extends to censoring scenes within a user-specified types of video content. For example, if a user objects to content displaying explicit sexuality or nudity, they user may implement this objection by indicating the type of content that is objectionable.

In some embodiments, the content location information that is returned from the backend system to the set top box might allow the receiver to take any of a number of actions. For example, the receiver could “blank” the content at the appropriate time, i.e., not display any audio or video for the scene in question. While the original content is being blanked, the user-side filtering application might present a popup or other graphic over a black or otherwise blank background. The pop up in this case would indicate, for example, that content filtering was active and that the audio/video would return momentarily.

In one aspect, a disclosed method for facilitating automated and user-specific filtering of multimedia content includes a backend server receiving a content identifier from a user's multimedia handling device (MHD), e.g., a set top box or other type of customer premises equipment (CPE). The content identifier indicates of a program of multimedia content (PMC) requested or otherwise desired by a user. The disclosed method includes identifying or otherwise locating an index file associated with the requested PMC. The index file includes data that indicates portions of the PMC containing potentially objectionable content. Content filtering (CF) settings associated with the user are retrieved or otherwise accessed. The CF settings define at least one type of content that is objectionable to the user. The CF settings are applied to the index file to identify a portion of the PMC containing content objectionable to the user content location information that indicates the identified portion of the PMC is then sent to the MHD.

The content location information may be implemented chronological content location information that indicates the beginning time and/or the ending time of the identified portion of the PMC. Alternatively, the content location information might include frame identification information that indicates a beginning frame and/or an ending frame of the identified PMC portion. The index file itself may be provided to the backend server by a third party, e.g., the owner or distributor of the PMC. In other embodiments, the service provider might create the index file from the PMC by performing at least audio and/or video analysis of the PMC. The types of objectionable content that a user may specify may include a word type, a scene type, as well as other types. The word type of objectionable content type might specify one or more words that are objectionable to the user or to viewers associated with the user including, e.g., the user's children or guests.

In another aspect, disclosed content filtering functionality is implemented in a user's CPE such as a set top box or other type of multimedia handling device (MHD). In this aspect an MHD includes a processor, storage media accessible to the processor, and a network interface to receive multimedia content from a content delivery server via an access network. The MHD may further include a decoder and a remote control interface. The decoder is configured to process multimedia content received from the content delivery server and to provide decoded content to a multimedia display device. The remote control interface processes remote control signals from a remote control.

The MHD may include software in the form of processor executable instructions, stored or otherwise embedded in the storage media. The software instructions include instructions to respond to detecting a remote control signal selecting a PMC by sending a content identifier to a backend server via the access network. The MHD instructions may further include instructions to respond to receiving content location information by modifying the PMC. The content location information indicates the location of selected or predetermines portions of the PMC and the MHD uses the content location information to prevent an audio component and/or a video component of an objectionable portion of the PMC from playing on the display device. The MHD may prevent the playing of the objectionable content by suppressing the audio and/or video component of the objectionable portion or by presenting alternative audio and/or video content in place of or “over” the objectionable portion. The alternative content may include, as an example, a video “pop up” that informs the viewer that content filtering is occurring or conveys some other message to the viewer. The MHD software may further include CF settings interface software that enables the user to specify types of objectionable content. The CF settings software might, for example, present a CF settings interface to the user and enable the user to interact with the interface using the remote control to create CF settings that define the types of content that are objectionable to the user.

In yet another aspect, a content filtering service or feature that is offered to a user in conjunction with a multimedia content distribution service is disclosed. The disclosed content filtering service includes enabling a user to create filter settings defining at least one type of multimedia content objectionable to a user and enabling the user to request a program of multimedia content (PMC). The service further includes providing content location information to a user's CPE. The content location information is indicative of a portion of the PMC containing content objectionable to the user. The disclosed service includes enabling the CPE to modify the PMC based at least in part on the content location information, wherein the modified PMC suppresses at least one of an audio component and a video component of the portion of the PMC indicated by the content location information. The types of objectionable content may include an objectionable word type and an objectionable scene type. An objectionable word type may specify one or more one objectionable words while an objectionable scene type may specify one or more objectionable visual elements. Providing the content location information may include querying an index file corresponding to the PMC using the filter settings. The index file includes information indicative of portions of the PMC containing potentially objectionable content.

In yet another aspect, a method of processing multimedia content is disclosed. The disclosed method includes receiving a multimedia stream corresponding to a predetermined PMC, and receiving content location information that indicates the location of a portion of the PMC containing objectionable content. The stream is decoded and the decoded content is modified by modifying the audio component and/or the video component of the objectionable portion of the PMC. Decoding may include decoding according to any of a variety of decoding algorithm selected including, as examples, MPEG-2, MPEG-4, WMV 7, WMV 8, and WMV 9. The processing method may also include sending a content identifier that indicates the PMC and storing content filter settings indicating at least one type of objectionable content.

In the following description, details are set forth by way of example to facilitate discussion of the disclosed subject matter. It should be apparent to a person of ordinary skill in the field, however, that the disclosed embodiments are exemplary and not exhaustive of all possible embodiments. Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

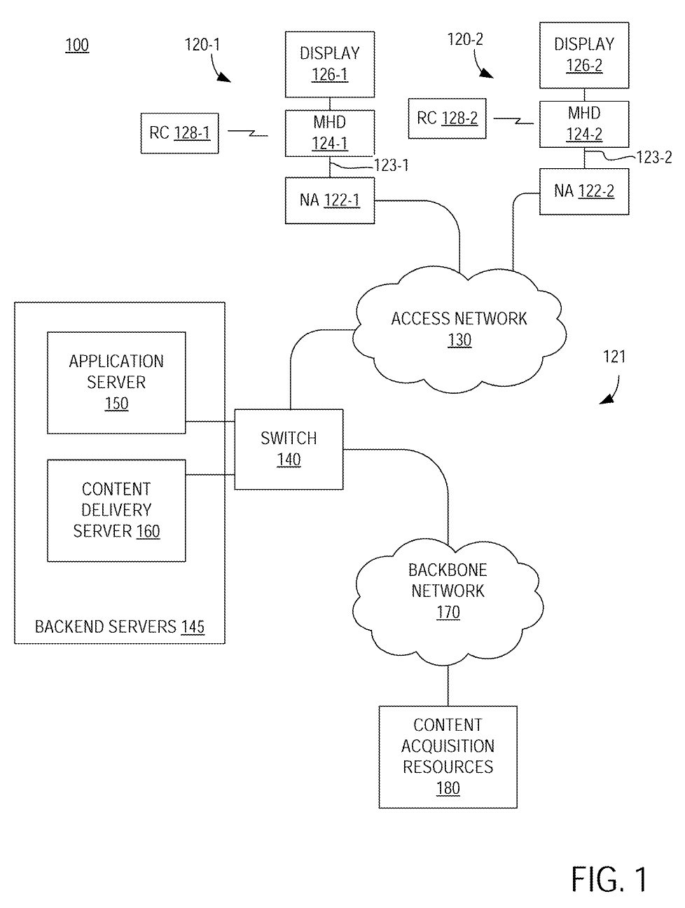

Turning now to the drawings, FIG. 1 is a block diagram illustrating selected elements of an embodiment of a multimedia content delivery network 100. The depicted embodiment of multimedia content delivery network 100 includes or supports functionality enabling an administrative user such as a parent to control or otherwise manage an other user's access to multimedia content. Although multimedia content is not limited to television, video-on-demand, or pay-per-view programs, the depicted embodiments of network 100 and its capabilities are described herein with primary reference to these types of multimedia content, which are sometimes referred to herein as programs of multimedia content (PMC).

The elements of multimedia content delivery network 100 illustrated in FIG. 1 emphasize the network's functionality for delivering multimedia content to one or more subscribers. As depicted in FIG. 1, multimedia content delivery network 100 includes one or more clients 120, where each client 120 may represent a different subscriber, and a service provider 121 that encompasses resources to acquire, process, and deliver programs to clients 120. Clients 120 and service provider 121 are demarcated by an access network 130 to which clients 120 and service provider 121 are connected. In some embodiments, access network 130 is an Internet protocol (IP) network and the delivery of multimedia content is packet based. In other embodiments, content may be digitally transmitted over access network 130 using a digital modulation scheme such as quadrature amplitude modulation (QAM).

In IP-based embodiments of access network 130, the physical layer of access network 130 may include unshielded twist pair copper cables, fiber optic cables, or both. Access network 130 may, for example, include digital subscribe line (DSL) compliant twisted pair connections between clients 120 and a node (not depicted) in access network 130 and fiber cable or another broadband medium connects service provider resources to a node in access network 130. In other embodiments, the broadband cable may extend all the way to clients 120. In embodiments of access networks that transmit content using digital or analog modulation, the physical layer may include co-axial cables and multimedia content delivery network 100 may include as a cable network.

The clients 120 depicted in FIG. 1 include a network appliance 122 that connects to access network 130 and to a multimedia handling device (MHD) 124. Network appliance 122 may supply routing, firewall, or other services for clients 120. In some embodiments, network appliance 122 may include elements of a broadband modem such as an asynchronous DSL (ASDL) modem as well as elements of a local area network (LAN) access point that supports a LAN 123 to which MHD 124 connects. LAN 123 may, in some embodiments, represent an Ethernet compliant LAN, also sometimes referred to as an IEEE 811 LAN. Clients 120 as depicted in FIG. 1 further include a display device or, more simply, a display 126. A remote control 128 of client 120 is operable to communicate requests or commands wirelessly to MHD 124 using infrared or radio frequency signals as is well known. MHDs 124 may also receive input via buttons (not depicted) located on side panels of MHDs 124.

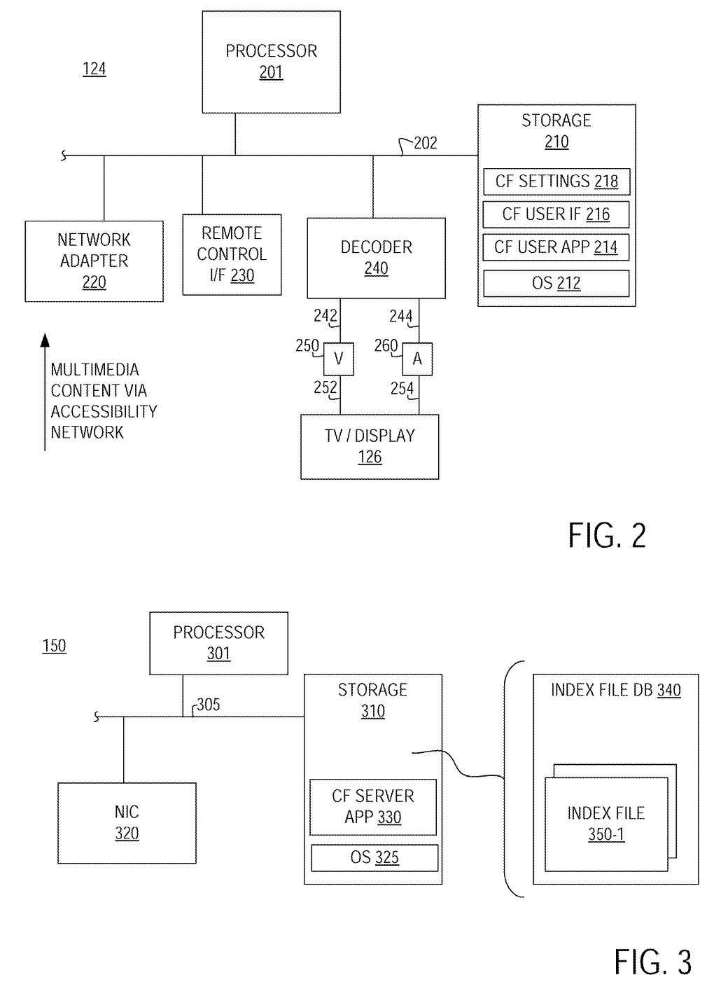

MHD 124 may be implemented as a customer premises equipment (CPE) device such as a stand-alone set top box suitable for use in a co-axial or IP-based multimedia content delivery network. In other embodiments, MHD 124 may be integrated with display 126, network appliance 122, or both. Selected elements of an embodiment of MHD 124 are described below with respect to FIG. 2.

As depicted in FIG. 1, the elements of service provider 121 include content acquisition resources 180 connected to a switch 140 via a backbone network 170. Server provider 121 as depicted further includes one or more backend servers 145 including, in the depicted embodiment, an application server 150 and a content delivery server 160 connected to switch 140. Switch 140 may provide firewall and routing functions to demarcate access network 130 from the resources of service provider 121. Switch 140 may be housed in a central office or other facility of service provider 121. In embodiments that employ DSL compliant connections, switch 140 may include elements of a DSL Access Multiplexer (DSLAM) that multiplexes many subscriber DSLs to backbone network 170. Backbone network 170 represents a private network, preferably a fiber based network, to accommodate tremendous data transfer rates. Content acquisition resources 180 as depicted in FIG. 1 encompasses the acquisition of various types of content including broadcast content, national content feeds, and video-on-demand content.

Multimedia content acquired by acquisition resources 180 is provided to a content delivery server 160 via backbone network 170 and switch 140. Multimedia content may be delivered from content delivery server 160 to clients 120 via access network 130 and switch 140. Content may be compressed, encrypted, modulated, demodulated, and otherwise encoded or processed at content acquisition resources 180, content delivery server 160, or both. Content delivery server 160 may support unicasting and multicasting. Unicasting consumes more bandwidth per subscriber than multicasting, but unicasting enables a service provider to offer low latency or no latency content delivery to a wide number of clients 120.

Although FIG. 1 depicts content acquisition resources 180 as a single element encompassing acquisition of all content, different types of content may be acquired via different types of acquisition resources. Similarly, although FIG. 1 depicts a single content delivery server 160, different types of content may be delivered by different servers. Moreover, embodiments of network 100 may employ a hierarchical structure of regional offices and one or more national offices. In such hierarchical embodiments, regional offices may includes their own content acquisition resources to acquire content not available to a national office including, as an example, regional broadcast content.

Application server 150 may host or otherwise implement one or more applications for network 100. Applications provided by application server 150 may be downloaded and hosted on other network resources including, for example, content delivery server 160, switch 140, and CPE such as network appliances 122 or MHDs 124. Selected elements of an embodiment of application server 150 are described in greater detail below with respect to FIG. 3.

Although service provider 121 is depicted in FIG. 1 as having a single switch 140 to which content acquisition, content delivery, and application servers are connected, other embodiments may employ different switches for each of these functional components and may include additional functional components not depicted in FIG. 1 including, for example, operational subsystem support (OSS) resources.

Referring now to FIG. 2, a block diagram illustrating selected elements of MHD 124 is presented. In the depicted embodiment, MHD 124 includes a processor 201 coupled via a shared bus 202 to storage media collectively identified as storage 210. Processor 201 may be a general purpose microprocessor such as an x86 type processor. In other embodiments, processor 201 may be implemented with any of various, commercially distributed embedded processors. Storage 210 encompasses persistent and volatile media, fixed and removable media, and magnetic and semiconductor media. Storage 210 is operable to store instructions, data structures, or both. Sets of instructions stored in storage 210 may be referred to as computer programs, application programs, software, and other terms that will be familiar to skilled artisans. Moreover, although storage 210 is shown in FIG. 2 as an element of MHD 124, storage 210 may include portions that are distributed, network hosted, or otherwise remotely located from MHD 124.

MHD 124 as depicted in FIG. 2 further includes a network adapter 220 that interfaces MHD 124 to LAN 123 and through which MHD 124 receives multimedia content. In embodiments employing IP-based access networks, multimedia content may be delivered to MHD 124 as a series of IP-compliant packets. In other embodiments, including digitally modulated cable-based embodiments of access network 130, multimedia content may be modulated into a particularly frequency band and transported simultaneously with multimedia content from other “channels,” which are modulated into their own respective carrier bands.

MHD 124 as shown includes a decoder 240. Multimedia content may be digitally compressed, encrypted, modulated, packetized, or otherwise formatted as it is received from access network 130. Decoder 240 is configured to process incoming multimedia content to generate a decoded video signal 242 and a decoded audio signal 244. For use with IP based implementations of access network 130, decoder 240 may include transport/demultiplexing resources to convert a series or set of IP-compliant packets into a video stream and an audio stream. For use with cable based embodiments of access network 130, decoder 240 may include one or more tuners to extract a desired stream of multimedia content by filtering a desired frequency band.

Decoder 240 is further configured to decrypt, descramble, and/or decompress multimedia content to generate native format video stream 242 and audio stream 244. The decompression performed by decoder 240 may comply with any of various video compression/decompression algorithms including, as examples, algorithms suitable for use with any of the Motion Pictures Expert Group (MPEG) or any of the Windows® Media Video (WMV) compression formats including, as examples, MPEG-2, MPEG-4 and WMV 7, WMV 8, and WMV 9. Similarly Decoder 240 may employ any of various audio decoding algorithms including Dolby® Digital, Digital Theatre System (DTS) Coherent Acoustics, and Windows Media Audio (WMA).

The native format video and audio streams 242 and 244 as shown in FIG. 2 may be processed by encoders/digital-to-analog converters (encoders/DACs) 250 and 260 respectively to produce analog video and audio signals 252 and 262 in a format compliant with display 126. Display 126 may comply with a National Television Systems Committee (NTSC), Phase Alternating Line (PAL), or any other suitable television standard.

Storage 210 as shown in FIG. 2 includes software in the form of an operating system 212, a content filtering user application (CF User App) 214, and a content filtering user interface (CF User I/F 216. Operating system 212 may represent a Unix or Unix-like operating system, a Windows® family operating system, or another suitable operating system. Embodiments of CF User App 214 may operate in conjunction with a data structure identified in FIG. 2 as CF User settings 218 and further in conjunction with one or more network hosted applications, network hosted data structures, or both. An example of such a network hosted application and data structure are described below with respect to FIG. 3.

In some embodiments, CF User App 214 includes instructions that, when executed, cause MHD 124 to modify multimedia content that is delivered to MHD 124 from backend servers 145 (FIG. 1) of server provider 121. CF User App 214 may modify multimedia content automatically and based on user-defined settings such as CF User Settings 218 to remove content deemed objectionable by the user. CF User Settings 218, in some embodiments, include information that defines one or more types of multimedia content that a subscriber or other user associated with MHD 124 has defined as objectionable.

Referring to FIG. 3, selected elements of an embodiment of application server 150 are illustrated. In the depicted embodiment, application server 150 includes a processor 301, storage media identified as storage 310, and a network interface adapter or NIC 320. In the depicted embodiment, processor 301 and NIC 320 connect to a shared bus 305 that provides access to storage 310. Storage 310 encompasses persistent and volatile media, fixed and removable media, and magnetic, optical, and semiconductor media. Storage 310 may include database structures, processor executable instructions, or both. The instructions embedded or otherwise stored in storage 310 as depicted in FIG. 3 include an operating system 325 and a content filtering server application (CF Server App) 330. Operating system 325 may be a Unix-based or Unix-like operating system, a Windows® based operating system, or another type of operating system. In addition, storage 310 as depicted in FIG. 3 includes a database structure identified as Index File database 340, which includes a one or more index files 350. Although CF Sever App 330 and Index File DB 340 are depicted as residing in storage 310 on a networked application server 150, all or portions of CF Server App 330, Index File DB 340, or both may stored on, downloaded to, and/or executed on another network resource including content delivery server 160, switch 140, network appliance 122, or elsewhere.

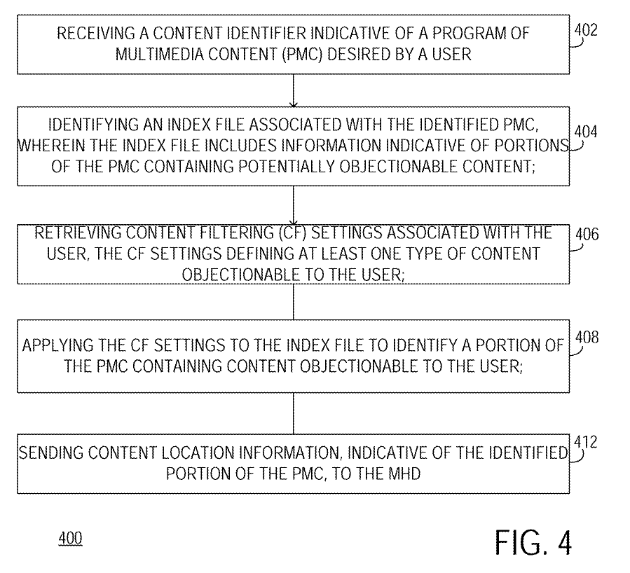

Turning now to FIG. 4, a flow diagram depicts selected elements of a method 400 suitable for facilitating the automated and user-specific filtering of multimedia content. In some embodiments, method 400 represents content filtering functionality embedded in application server 150 and, more specifically, CF Server App 330. In the depicted embodiment, method 400 includes receiving (block 402) a content identifier that indicates or otherwise conveys the identity of a program of multimedia content (PMC) desired by a client-side user, i.e., a user of MHD 124. The content identifier may be initiated, for example, when the user changes to a particular channel or interacts with a user interface generated by MHD 124.

Method 400 as shown in FIG. 4 may further including identifying (block 404) an index file associated with the identified PMC. The index file (350) may include information from which one might determine which, if any, portions of the desired PMC containing potentially objectionable content. In some embodiments, the index file 350 is implemented in the form of a script or set of tags that provide an outline of the PMC, particularly with respect to content that is potentially objectionable to a user. The index file 350 may conform with a defined or predetermined set of content types. An index file 350 might for example, include information that indicates the portions of a PMC that contain profanity or certain specified words, scenes of violence, scenes of nudity or other explicit or implied sexuality, scenes of hatred, and so forth.

The depicted embodiment of method 400 includes retrieving (block 406) or otherwise accessing or reading content filtering (CF) settings 218 associated with the user. CF settings 218 may define at least one type of content that is objectionable to the user. Method 400 as shown then applies (block 408) the CF settings 218 to the index file 350 to identify portions of the PMC containing content that is objectionable to the user. In some embodiments, method 400 applies the CF settings 218 by using the CF settings 218 to query or otherwise search Index File 350 to identify information in Index File 350 pertaining to any of the objectionable content types defined by CF settings 218.

Method 400 as depicted in FIG. 4 then sends (block 412) content location information to the user of MHD 124. The content location information sent to the MHD 124 includes information that identifies the portions of the PMC containing objectionable content. The PMC portions may be identified based on timing information, e.g., the scene beginning at 42 minutes and 17 seconds from a PMC starting point or frame information, e.g., the beginning at the video stream frame having a frame ID of X. Once the content location information is conveyed to the user, the user side application may modify the content based on the content location information to suppress or otherwise modify the content defined by the content location information. In the embodiment depicted and described herein, the backend server 145 do not perform the actually filtering of the multimedia content, but instead provide information enabling filtering at the client side by MHD 124 or another suitable client side resource. This “local filtering” approach beneficially reduces the number of streams of content that have to be transmitted to a subscriber base because the customization of the streams is performed by a client's CPE. In other embodiments not depicted, however, the filtering functionality may be implemented in the backend servers so that content delivered to a client is already filtered for content according to the user's filtering preferences.

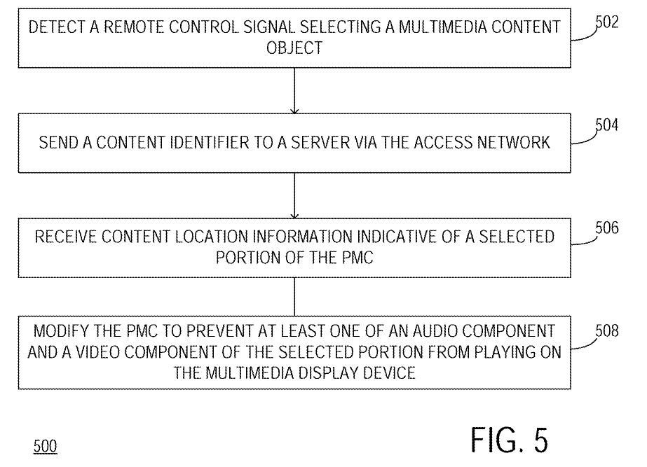

Turning now to FIG. 5, a flow diagram depicts selected elements of a method 500 for modifying multimedia content based on user-defined content objections. Method 500 may represent functionality that is included in MHD 124 and, more specifically, CF User App 214. In the depicted embodiment, method 500 includes detecting (block 502) a remote control signal that identifies a desired PMC. The remote control signal might be initiated, for example, when a user changes channels, powers on the MHD 124, or interacts with some form of on-demand or pay-per-view interface. Method 400 responds to detecting the signal in block 502 by sending (block 504) a content identifier to a backend server such as application server 150 via access network 130. After sending the content identifier, method 400 then awaits the receipt (block 506) of the content location information generated by CF Server App 330. The content location information is then used by CF User App 214 to modify (block 508) the multimedia content.

CF User App 214 may achieve content modification by monitoring or communicating with decoder 240. CF User App 214 may, for example, monitor timing information that decoder 240 generates or frame processing performed by decoder 240. Decoder 240 may be configured to enable external resources to access or otherwise monitor certain parameters and CF User App 214 may leverage such information to facilitate the content filtering.

For example, in a time based filtering application, CF User App 214 may monitor timing information associated with a PMC that is currently playing. CF User App 214 may monitor specifically for a particular value of a real time clock or other timing and compare the timing value to its content location information that indicates the chronological location of objectionable content. When the real time clock value matches a value in a content location information, CF User App may send signals to decoder 240 that cause decoder 240 to modify the content by, for example. suppressing the content or by substituting alternative content during an interval when objectionable content is playing. In the case of substituted content, the content that CF User App 214 substitutes for the original content may explicitly inform the user or viewer that the original content is being blocked according to the user's CF settings.

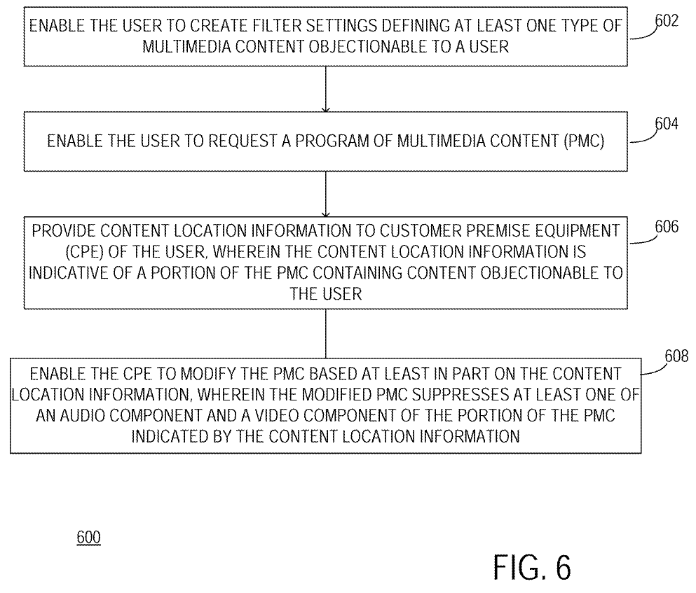

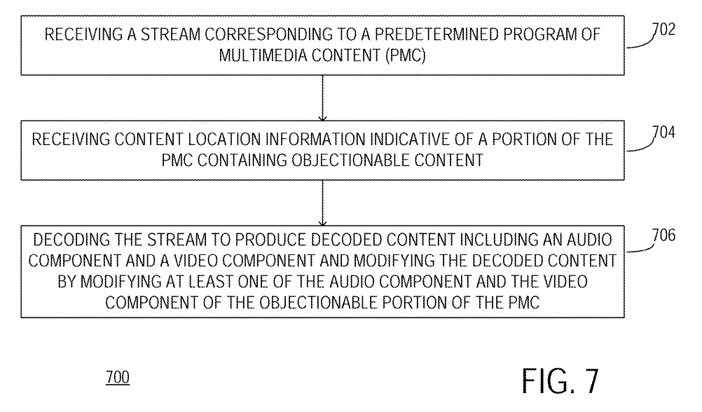

Turning now to FIG. 6, a flow diagram illustrates selected elements of a content filtering service 600 that may be provided to a subscriber or other user by service provider 121 or a third party. In the depicted embodiment, method 600 includes enabling (block 602) a user to create filter settings that define one or more type of multimedia content that are objectionable to the user. In some embodiments, the user is enabled to define filter settings using a CF settings interface 216 that is downloaded or otherwise made accessible to users that subscribe to the service or to all users. In an exemplary embodiment CF settings interface 216 is implemented as an on screen menu that includes selectable elements navigable using a conventional or universal IR or RF remote control device. The CF settings interface may prompt the user to select specific types of content that are objectionable from a list of standard content types. Alternatively, the CF settings interface 216 may enable the user to enter specific text or other information to define different or more specific types of content. As one example, CF settings interface 216 may enable the user to define specific words that represent, in an of themselves, objectionable content.

Method 600 as depicted in FIG. 6 further includes enabling (block 602) the user to request a PMC, such as by changing channels or otherwise interacting with MHD 124 using a remote control or controls mounted on a front panel, top panel, or side panels of MHD 124. As discussed previously, the selection or indication of a PMC may cause the MHD 124 to transmit a content identifier to backend servers 145.

Following the indication of a PMC by the user, the content filtering service responds by providing (block 606) content location information to the user's CPE. The content location information includes information that identifies or otherwise indicates the portions of the PMC containing content that is objectionable to the user as defined by the user's CF settings 218. The CF filtering service 600 as shown in FIG. 6 further includes enabling (block 608) the user's CPE to modify the PMC based, at least in part, on the content location information. The PMC as modified by CF User App 214 may suppresses audio or video portions of the objectionable content or provide alternative or substitute content such as pop up video content and/or a “beeping” or other substitute audio content that effectively blocks the original objectionable content.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating automated user-specific filtering of multimedia content, comprising:
receiving a content identifier indicative of a program of multimedia content (PMC) desired by a user;
identifying an index file associated with the identified PMC, wherein the index file includes information indicative of portions of the PMC containing potentially objectionable content;
retrieving content filtering (CF) settings associated with the user, the CF settings defining at least one type of content objectionable to the user;
applying the CF settings to the index file to identify a portion of the PMC containing content objectionable to the user; and
sending content location information, indicative of the identified portion of the PMC, to a multimedia handling device.

2. The method of claim 1, wherein the content location information comprises chronological content location information indicative of at least one of a beginning time and an ending time of the identified portion.

3. The method of claim 1, wherein the content location information comprises frame identification information indicative of at least one of a beginning frame and an ending frame of the identified portion.

4. The method of claim 1, further comprising receiving the index file from a provider of the PMC.

5. The method of claim 1, further comprising generating the index file from the PMC by performing at least one of audio and video analysis of the PMC.

6. The method of claim 1, wherein the at least one type of content objectionable to the user is a word type specifying at least one objectionable word.

7. A multimedia handling device (MHD) including a processor and storage media accessible to the processor, the MHD comprising:
a network interface to receive multimedia content from a content delivery server via an access network;
a decoder configured to process the multimedia content and to provide decoded content to a multimedia display device;
a remote control interface to process remote control signals from a remote control;
processor executable instructions, embedded in the storage media including instructions to:
respond to detecting a remote control signal selecting a multimedia content object by sending a content identifier to a server via the access network; and
respond to receiving content location information indicative of a selected portion of the multimedia content object by modifying the multimedia content object to prevent at least one of an audio component and a video component of the selected portion from playing on the multimedia display device.

8. The device of claim 7, wherein preventing comprises presenting alternative content in place of the selected portion.

9. The device of claim 8, wherein the alternative content conveys the occurrence of content filtering to a viewer of the multimedia content object.

10. The device of claim 7, wherein preventing comprises suppressing at least one of the audio component and the video component from playing.

11. The device of claim 7, wherein the instructions further comprise instructions to respond to a predetermined sequence of at least one remote control signal by displaying a filter settings interface on the display device wherein the filter setting interface is enabled to respond to filter setting remote control signals by creating or modifying filter setting data defining objectionable content.

12. A content filtering service offered to a user in conjunction with a multimedia content distribution service, the content filtering service comprising:
enabling the user to create filter settings defining at least one type of multimedia content objectionable to the user;
enabling the user to request a program of multimedia content (PMC);
providing content location information to customer premise equipment (CPE) of the user, wherein the content location information is indicative of a portion of the PMC containing content objectionable to the user;
enabling the CPE to modify the PMC based at least in part on the content location information, wherein the modified PMC suppresses at least one of an audio component and a video component of the portion of the PMC indicated by the content location information.

13. The service of claim 12, wherein the at least one type of objectionable content comprises a type selected from the group consisting of an objectionable word type and an objectionable scene type, wherein the objectionable word type specifies at least one objectionable word and the objectionable scene type specifies at least one objectionable visual element.

14. The service of claim 12, wherein providing the content location information includes querying an index file corresponding to the PMC using the filter settings, wherein the index file contains information indicative of portions of the PMC containing potentially objectionable content.

15. The service of claim 12, wherein the content location information is indicative of at least one of a beginning time and an ending time of the portion of the PMC containing objectionable content.

16. The service of claim 12, wherein the content location information is indicative of at least one of a beginning frame and an ending frame of the portion of the PMC containing objectionable content.

17. A method of processing multimedia content, comprising:
receiving a stream corresponding to a predetermined program of multimedia content (PMC);
receiving content location information indicative of a portion of the PMC containing objectionable content; and
decoding the stream to produce decoded content including an audio component and a video component and modifying the decoded content by modifying at least one of the audio component and the video component of the objectionable portion of the PMC.

18. The method of claim 17, wherein decoding comprises decoding according to a decoding algorithm selected from the group consisting of MPEG-2, MPEG-4, WMV 7, WMV 8, and WMV 9.

19. The method of claim 17, further comprising:
sending a content identifier indicative of the PMC; and
storing content filter settings indicative of at least one type of objectionable content.

20. The method of claim 17, wherein modifying at least one of the audio component and the video component comprises suppressing at least one of the audio component and the video component.

21. The method of claim 17, wherein modifying at least one of the audio component and the video component comprises providing at least one an alternative audio component and an alternative video component.
